(19) United States
(12) Patent Application Publication
(10) Pub. No.: US 2009/0219547 A1
(43) Pub. Date: Sep. 3, 2009

(54) Method and Device for Position Sensing in an Imaging System

(76) Inventors: Petteri Kauhanen, Espoo (FI); Jarkko Rouvinen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/223,497

(22) PCT Filed: Feb. 6, 2006
(86) PCT No.: PCT/IB2006/000223

§ 371 Date: Apr. 2, 2009

(51) Int. Cl. G01B 11/14

(52) U.S. Cl. 356/615

(57) ABSTRACT

In a camera where the lens or image sensor is laterally moved in a carrier to shift the image for compensating for unwanted camera movement, a reflection surface is used to reflect light, and a photo-emitter/sensor pair is used to illuminate the reflection surface and to detect reflected light therefrom. Reflection surface is provided near the edge of one carrier section e and photo-emitter/sensor pair is disposed on another carrier section. These sections are movable relative to each other for imaging shifting purposes. The photo-emitter/sensor pair is positioned such that the light cone emitted by the photo-emitter partly hits the V reflection surface and partly falls beyond the edge. As the photo-emitter/sensor pair and the reflection surface move relative to each other, the area on the reflection surface illuminated by the photo-emitter changes causing a change in the amount of detected light.

### FIELD OF THE INVENTION

The present invention relates generally to optical position sensing in an imaging system and, more particularly, to position sensing for the optical image stabilizer.

### BACKGROUND OF THE INVENTION

Imaging applications such as optical image stabilizers, optical zoom systems and auto-focus lens systems require high precision in position sensing. In general, needed accuracy is in the order of few microns. Sensor output linearity and immunity to external disturbances is important. Furthermore, the operation mode for position sensing also requires non-contact operation to avoid mechanical wear.

Optical image stabilization generally involves laterally shifting the image projected on the image sensor in compensation for the camera motion. Shifting of the image can be achieved by one of the following general techniques:

Lens shift—this optical image stabilization method involves moving one or more lens elements of the optical system in a direction substantially perpendicular to the optical axis of the system;

Image sensor shift—this optical image stabilization method involves moving the image sensor in a direction substantially perpendicular to the optical axis of the optical system;

Camera module tilt—this method keeps all the components in the optical system unchanged while tilting the entire module so as to shift the optical axis in relation to a scene.

In any one of the above-mentioned image stabilization techniques, a mechanism is required to effect the change in the optical axis or the shift of the image sensor by moving at least one of the imaging components. Furthermore, a device is used to determine the position of the moved imaging component.

In prior art, Hall sensors are used where voice coil actuators are used for image stabilization. Alternatively, a reflector with a high reflection area and a low reflection area or a reflector with gray-scale pattern is used for position sensing purposes.

The present invention provides a different method and device for position sensing.

### SUMMARY OF THE INVENTION

The present invention uses a reflection surface to reflect light, and a photo-emitter and photo-sensor pair to illuminate the reflection surface and to detect the reflected light from the reflection surface. In particular, the reflection surface is provided near the edge of a first frame and the photo-emitter/sensor pair is disposed on a second frame. The first and second frames are moved relative to each other when the first frame is used to move one of the imaging components in an imaging system. The photo-emitter/sensor pair is positioned at a distance from the reflection surface such that the light cone emitted by the photo-emitter only partly hits the reflection surface. Part of the light cone misses the reflection surface because it falls beyond the edge. As the photo-emitter/sensor pair and the reflection surface move relative to each other, the area on the reflection surface illuminated by the photo-emitter changes. Accordingly, the amount of light sensed by the photo-sensor also changes. The change in the reflected light amount causes a near-linear output signal response in a certain travel range of the reflection surface. Preferably, the reflectivity of the reflection surface within the illuminated area is substantially uniform and the distance between the photo-emitter/sensor pair and the reflection surface is substantially fixed. As such, the output signal response is substantially proportional to a portion of a circular area of a fixed radius and the portion is reduced or increased as a function of a moving distance as the photo-emitter/sensor pair and the reflection surface move relative to each other.

In one of the embodiments of the present invention, the diameter of the illuminated area is smaller than the width of the reflection surface.

In another embodiment of the present invention, the diameter of the illuminated area is equal to or greater than the width of the reflection surface.

In yet another embodiment of the present invention, the reflection surface has a wedge shape.

In a different embodiment of the present invention, two photo-emitter/sensor pairs disposed at two reflection surfaces for sensing the relative movement in a differential way.

The present invention will become apparent upon reading the description taken in conjunction with FIGS. 3a to 14.

### BRIEF DESCRIPTION OF THE DRAWINGS

FIG. 1 is a schematic representation of an imaging system wherein the image sensor is moved relative to the lens for optical image stabilization purposes.

FIG. 2 is a top view of a carrier which is used to shift the image sensor in two directions parallel to the image plane.

FIG. 3a and 3b show a fixedly disposed photo-emitter/sensor pair positioned in relationship to a movable frame having a reflection surface near the edge of the frame.

FIG. 4 shows a photo-emitter/sensor pair positioned in relationship to a movable frame having a reflection surface near an edge of a slot.

FIG. 5 shows a photo-emitter/sensor pair disposed on a movable frame in relationship to a fixed frame having a reflection surface.

FIG. 6 shows a plot of output signal against the relative position between a photo-emitter/sensor pair and the reflection surface.

FIG. 7 shows another embodiment of the present invention.

FIG. 8 shows yet another embodiment of the present invention.

FIG. 9 shows two photo-emitter pairs positioned in relationship to two separate reflection surfaces near two edges of a frame.

FIG. 10 illustrates an imaging system wherein a prism is used to fold the optical axis.

FIG. 11 illustrates how the prism in the imaging system of FIG. 11 can be rotated for image stabilization purposes.

FIG. 12 illustrates a gimballed prism for rotation about two axes.

FIG. 13 shows a photo-emitter pair positioned for sensing the rotation of the prism about one axis.

FIG. 14 shows another photo-emitter pair positioned for sensing the rotation of the prism about another axis.

### DETAILED DESCRIPTION OF THE INVENTION

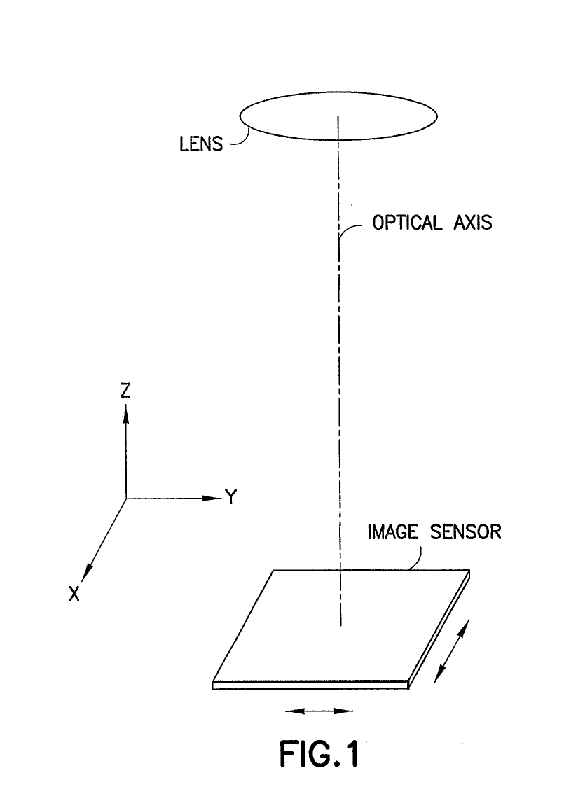

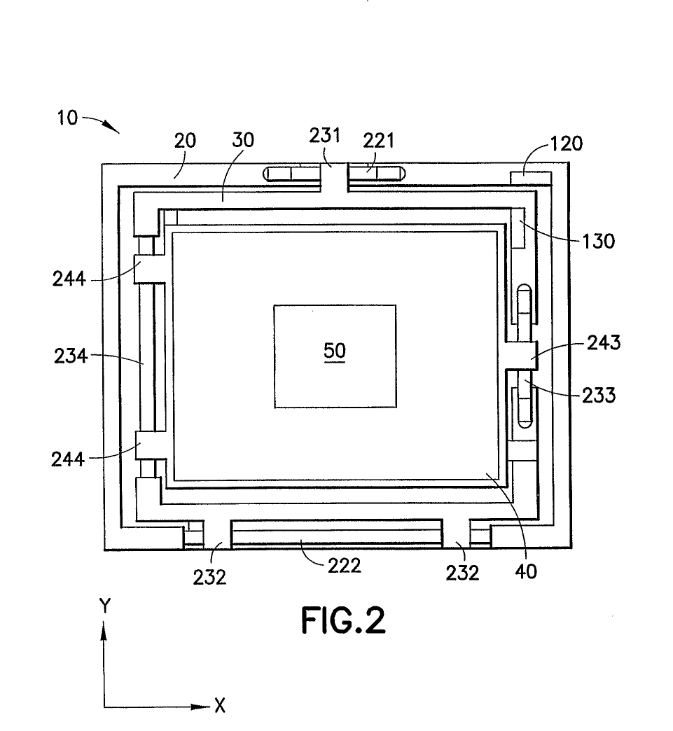

Imaging applications such as optical image stabilizers, optical zoom systems and auto-focus lens systems require high precision in position sensing. In optical image stabilization, one of the imaging components in the imaging system is shifted parallel to the image plane for reducing image blur as a result of an unwanted movement during the exposure. In order to illustrate how position sensing, according to the present invention, is carried out in an imaging system, as shown in FIG. 1, it is assumed that the image sensor is mounted on a carrier so that the image sensor can be moved in the X-direction and the Y-direction. An exemplary carrier is shown in FIG. 2.

As shown in FIG. 2, the carrier 10 has an outer frame 20, an inner frame 30 and a plate 40 for mounting an image sensor 50. The outer frame 20 has a guide pin 221 and a guide pin 222 fixedly mounted on the frame 20. The inner frame 30 has a bracket 231 movably engaged with the guide pin 221 and a pair of brackets 232 movably engaged with the guide pin 222 such that the inner frame 30 can be caused to move in the X-direction. Similarly, the inner frame 30 has a guide pin 233 and a guide pin 234 fixedly mounted on the frame 30. The plate 40 has a bracket 243 movably engaged with the guide pin 233 and a pair of brackets 244 movably engaged with the guide pin 234 such that the plate 40 can be caused to move in the Y-direction. As such, the image sensor 50 can be shifted in both the X and Y directions for optical image stabilization purposes.

It should be noted that a carrier, similar to that of carrier 10, can be used to move a lens element, instead of the image sensor 50, in a direction parallel to the image plane for shifting the image projected on the image sensor 50 for optical image stabilization purposes.

In order to measure the relative movement in the X-direction between the inner frame 30 and the outer frame 20, a position sensing system 120, is used. In order to measure the relative movement in the Y-direction between the plate 40 and the inner frame 30, a position sensing system 130 is used.

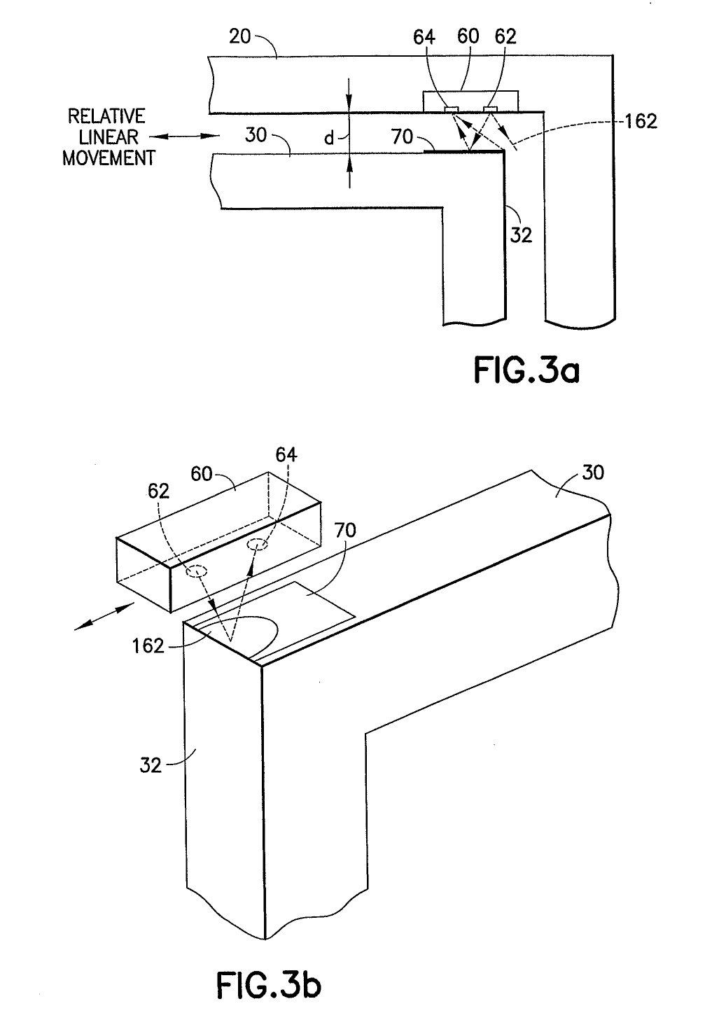

In one embodiment of the present invention shown in FIGS. 3a and 3b, the position sensing system 120 comprises a photo-emitter/sensor pair 60 and a reflection surface 70. The photo-emitter/sensor pair 60 has a photo-emitting element, such as an LED 62, for illuminating part of the reflection surface 70. The emitter/sensor pair 60 also has a photo-sensor 64 to sense the amount light reflected by the reflection surface 70. As shown in FIGS. 3a and 3b, the reflection surface 70 is provided near a corner of the movable inner frame 30 whereas the emitter/sensor pair 60 is fixedly mounted on the outer frame 20 facing the reflection surface 70. The distance and position between the emitter/sensor pair 60 and the reflection surface 70 is chosen such that the light cone 162 emitted by the photo-emitting element 62 only partially hits the reflection surface 70. Part of the light cone 162 misses the reflection surface 70 as it falls beyond the edge 32 of the frame 30.

Preferably, the reflectivity of the reflection surface within the illuminated area is substantially uniform and the distance, d, between the photo-emitter/sensor pair 60 and the reflection surface 70 is also fixed. As such, the output signal response from the photo-sensor 64 is substantially proportional to a portion of a circular area of a fixed radius and the portion is reduced or increased as a function of a moving distance as the photo-emitter/sensor pair and the reflection surface move relative to each other.

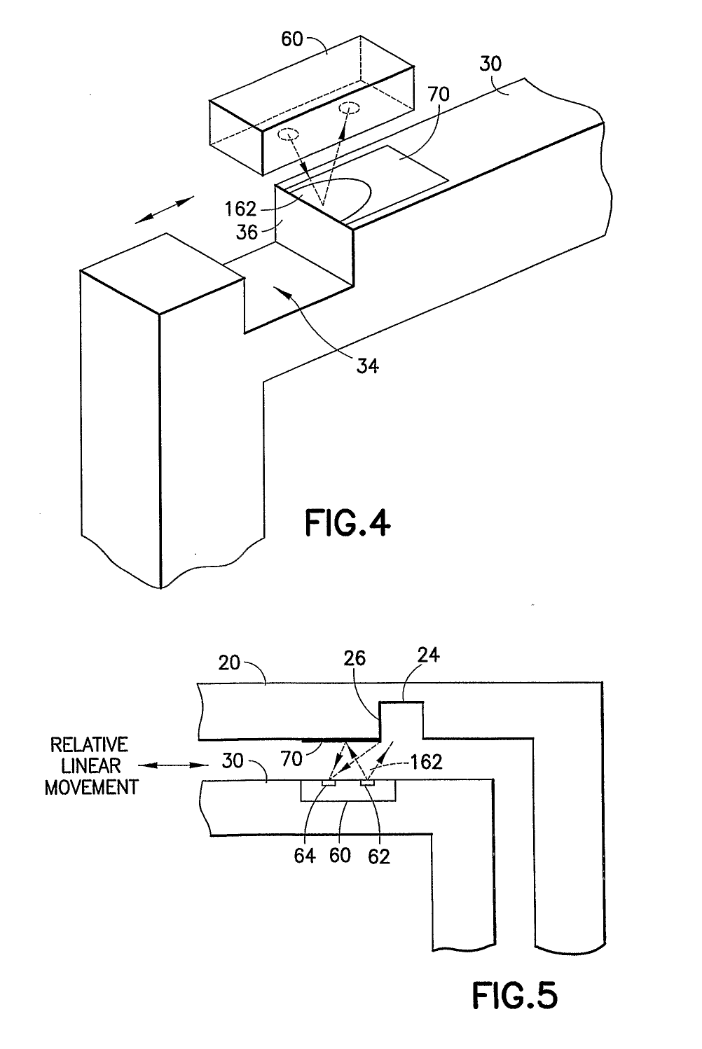

It should be noted that the edge of a frame is not necessarily formed at a corner of the frame, as shown in FIGS. 3a and 3b. The edge can be made with a slot on the frame, for example. As shown in FIG. 4, the frame 30 has a slot 34 with an edge 36. The photo-emitter/sensor pair 60 is positioned on the outer frame 20 near the slot 34 so that the light cone emitted by the photo-emitter 62 hits only part of the reflection surface 70.

In FIGS. 3a to 4, the reflection area 70 is depicted as being provided on the inner frame 30 which is movably mounted on the fixed outer frame 20 for linear movement. It should be noted that, the reflection area 70 can also be provided on the fixed outer frame 20 while the photo-emitter/sensor pair 60 is mounted to the inner frame 30, as shown in FIG. 5. In order to provide an edge 26, a slot 24 is made on the outer frame 20 and the reflection surface 70 is provided near the edge 26. Moreover, it is understood by a person skilled in the art that the photo-emitter/sensor pair 60 is operatively connected to a power supply for providing electrical power to the photo-emitter 62 and to an output measurement device 260 so that the output signal from the photo-sensor 64 can be measured for determining the relative movement between the photo-emitter/sensor pair 60 pair and the reflection surface 70.

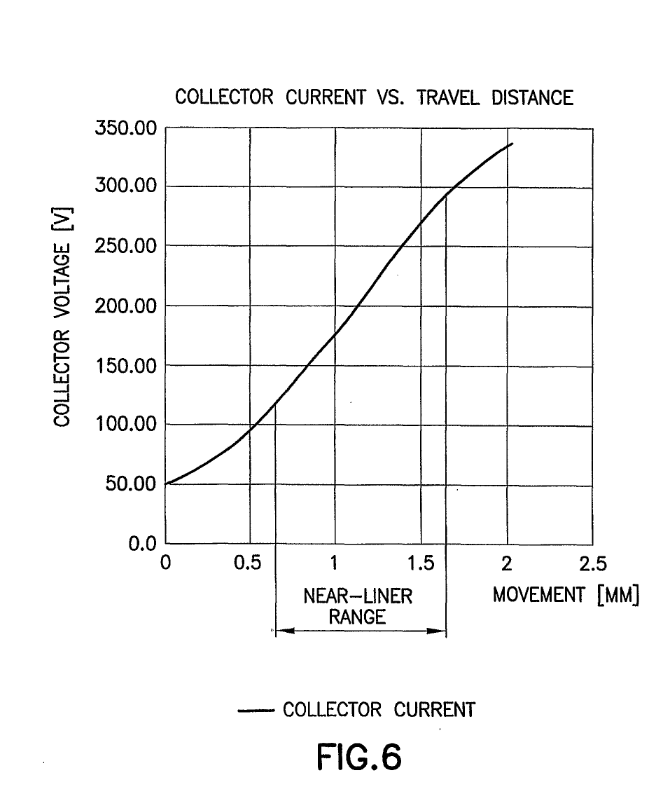

The measured output signal from the photo-sensor 64, in terms of collector current as a function of movement distance, is shown in FIG. 6. As shown, a near-linear range of approximately 1 mm can be found in the middle of curve. Within this range, the measurable movement in the order of few microns is attainable.

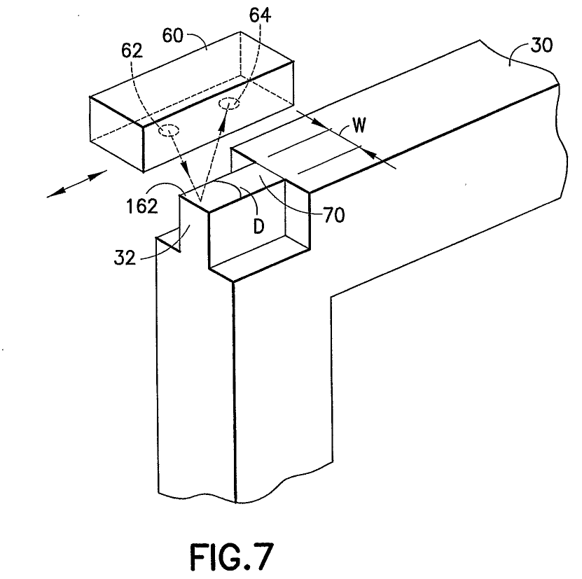

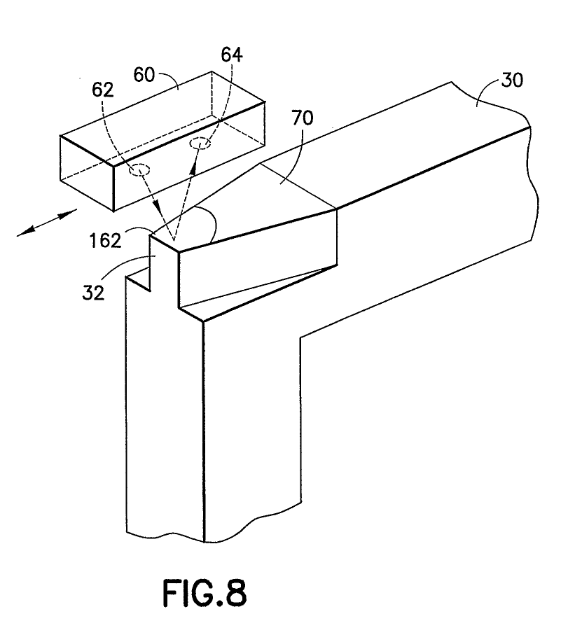

It should be appreciated by a person skilled in the art that the edge 32, 36 and 26 as depicted in FIGS. 3a to 5 is part of a frame surface that is substantially perpendicular to the reflection surface. However, the angle between the frame surface and the reflection surface is not necessarily a right angle. The angle can be larger than 90 degrees or smaller than 90 degrees, so long as the part of the light beam from the photo-emitter 62 falling beyond the edge does not yield a significant amount of detectable light as compared to the reflected light from the reflection surface. Furthermore, in FIGS. 3b and 4, the width of the reflection surface 70 is greater than the diameter of the light cone 162 on the reflection surface. However, the width w of the reflection surface 70 can be equal to or smaller than the diameter D of the light cone 162 on the reflection surface, as shown in FIG. 7. Moreover, the reflection surface 70 can also be a wedge-shaped surface, as shown in FIG. 8.

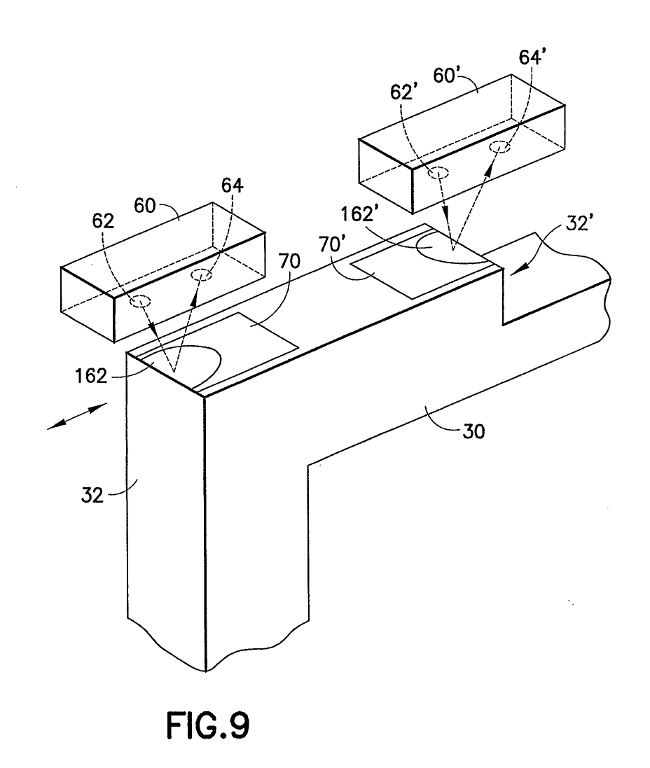

In a different embodiment of the present invention, two separate optical sensors are used on one motion axis to form a differential position system. As shown in FIG. 9, a photo-emitter/sensor pair 60 has a photo-emitter 62 for projecting a light cone 162 on a reflection surface 70, and a photo-sensor 64 for sensing the amount light reflected by the reflection surface 70. A separate photo-emitter/sensor pair 60′ has a photo-emitter 62′ for projecting a light cone 162′ on a different reflection surface 70′, and a photo-sensor 64′ for sensing the amount of light reflected by the reflection surface 70′. As shown in FIG. 9, the reflection surface 70 is provided near an edge 32 of the frame 30, and the reflection surface 70′ is provided near another edge 32′ of the same frame 30. The distance between the photo-emitter pair 60 and the photo-emitter pair 60′ is fixed so that when the position signal of one photo-emitter/sensor pair is increased due to the relative movement between frame 30 and the photo-emitter pairs, the position signal of the other photo-emitter pair is decreased. As such, the final position signal is the difference of the two separate position signals. With the arrangement as shown in FIG. 9, external influences such as temperature changes can be substantially eliminated. Furthermore, the effect of mechanical tilting is reduced.

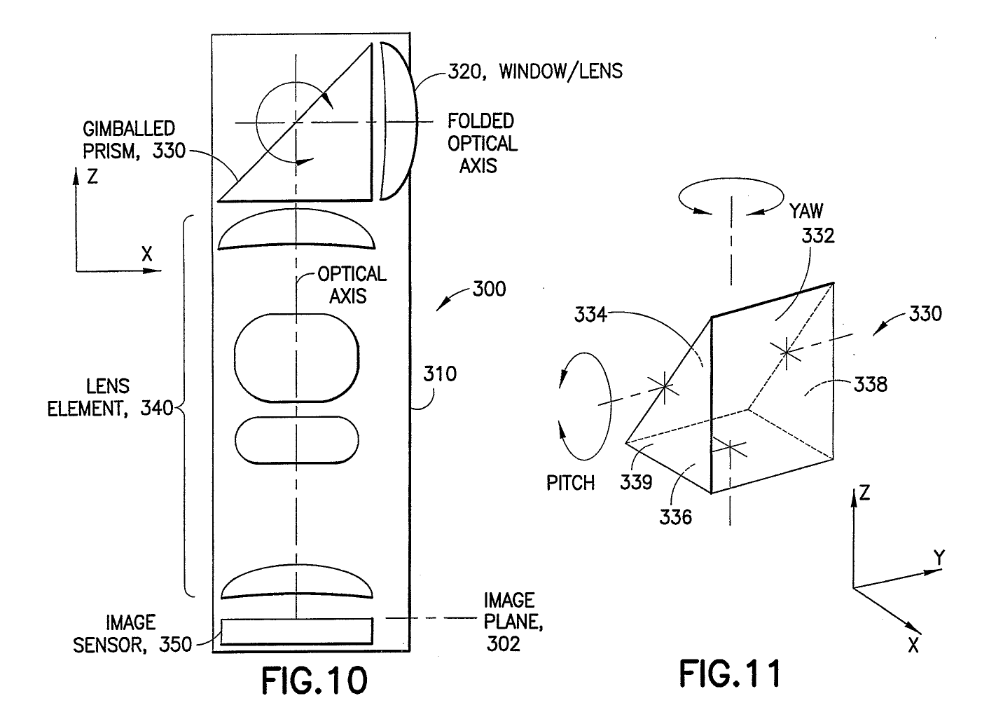

The position sensing method and system, according to the present invention, can also be used in an imaging system where a reflection surface, such as a prism or a mirror, is used to fold the optical axis of the imaging system. The reflection surface can also be rotated to shift the image projected on the image plane for image stabilization purposes. As shown in FIG. 10, the imaging system 300 comprises a system body 310 for housing an image sensor 350 located on the image plane 302, a front lens or window 320, a triangular prism 330 and possibly a plurality of other lens elements 340. When a user uses the imaging system 300 to take pictures, the user's hand may involuntarily shake, causing the mobile phone to rotate around the Y-axis in a pitch motion, and to rotate around the Z-axis in a yaw motion. These motions may introduce a motion blur to an image being exposed on the image sensor 350.

In order to compensate for the pitch and yaw motions during the exposure time, an optical image stabilizer is used. The optical image stabilizer comprises two movement means, such as motors or actuators for causing the prism to rotate around two axes. The rotation axes of the prism are shown in FIG. 11. As shown in FIG. 11, the prism 330 has two triangular faces 338, 339 substantially parallel to the Z-X plane, a base 336 substantially parallel to the X-Y plane, a front face 332 substantially parallel to the Y-Z plane and a back face 334 making a 45 degree angle to the base 336. In order to reduce the motion blur, the prism may be caused to rotate around the Z-axis and the Y-axis.

As known in the art, when light enters the prism from its front face 332 in a direction parallel to the X-axis, the light beam is reflected by total internal reflection (TIR) at the back face 334 toward the image sensor 330.

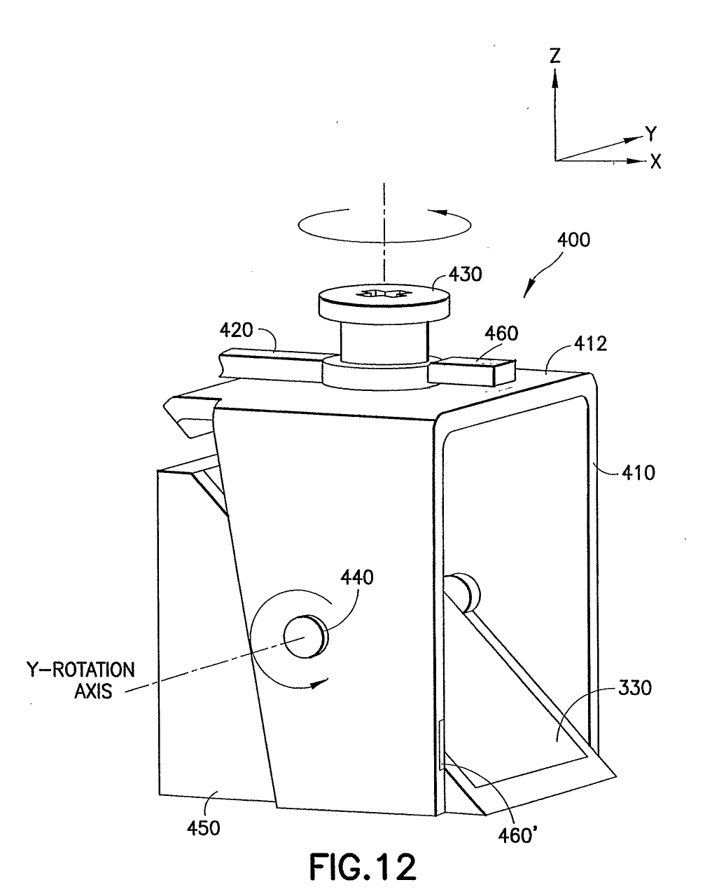

The tilting of the prism can be achieved by using a gimballed joint 400 to mount the prism 330 for rotation at pivot 430 and pivot 440, as shown in FIG. 12. The gimballed joint 400 is rotatably mounted on a mount 420 which is fixedly mounted to the system body 310 of the imaging system (see FIG. 10). The gimballed joint 400 has a frame 410 operatively connected to the pivot 430 for rotation about the Z-axis relative to the mount 420. A prism mount 450, which is used to carry the prism 330, is rotatably mounted on the frame 410 at pivot 440 so as to allow the prism to rotate about the Y-axis. In order to sense the position of the prism relative to the system body 310, a photo-emitter/sensor pair 460 is used to sense the position of a surface 412 of the frame 410 and another photo-emitter/sensor 460′ is used to sense the position of the prism mount 450.

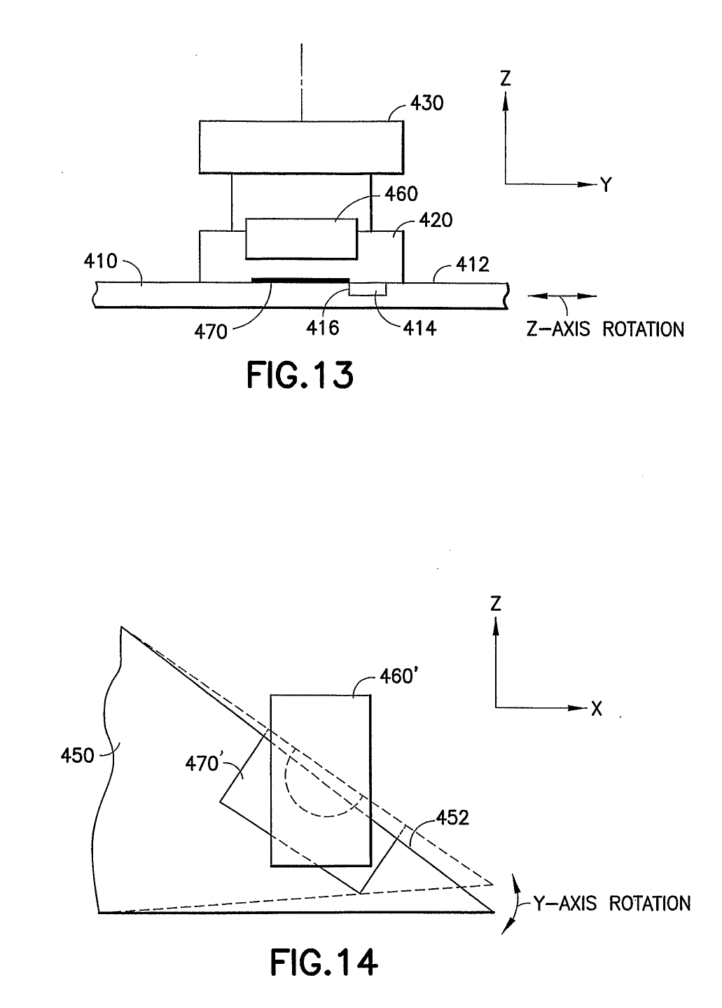

As shown in FIG. 13, the surface 412 has an aperture or slot 414 to provide an edge 416 near a reflection surface 470 so as to allow the photo-emitter/sensor pair 460 to sense the relative movement of the surface 412 relative to the mount 420. Likewise, a reflection surface 470′ is provided on the surface of the prism mount 450 near an edge 452 so as to allow the photo-emitter/sensor pair 460′ to sensor the relative movement of the prism mount 450 relative to the frame 410.

It should be noted that optical sensors such as photo-emitter/sensor pairs are low-end components and, thus, the performance variation is generally quite large. It would be advantageous and desirable to calibrate the position system during start-up of the optical image stabilizer. This can be done by driving the moving member (lens, image sensor) over the entire available motion range, for example. During this stroke, the sensor output is measured at both extremes of the motion range. When the output signals at the two extremes are known, all the intermediate positions can be accurately determined from the intermediate output signals.

Although the invention has been described with respect to one or more embodiments thereof, it will be understood by those skilled in the art that the foregoing and various other changes, omissions and deviations in the form and detail thereof may be made without departing from the scope of this invention.

1. An imaging system comprising:
an image forming medium located at an image plane;
at least a lens element for projecting an image on the image forming medium, the lens element defining an optical axis;
a carrier arranged to shift the projected image relative to the image plane in response to an unwanted movement of the imaging system, the shifting means having a first carrier section fixedly connected to a body portion of the imaging system and a second carrier section for mounting an optical component for movement relative to the first section;
a position sensor configured to sense the position of the second carrier section relative to the first carrier section, said position sensor comprising:
a reflection surface provided on one of the first and second carrier sections, the reflection surface located adjacent to an edge of a carrier section surface,
a light emitting element, disposed on the other of the first and second carrier sections spaced from the reflection surface, for producing a light beam to illuminate the reflection surface such that one part of the light beam encounters the reflection surface to form an illuminated area, and another part of the light beam falls off the edge of the carrier section surface, and
a light sensor configured to sense the light reflected from the illuminated area for providing an electrical output having a relationship to the illuminated area, wherein when the second carrier section is caused to undergo a movement relative to the first carrier section, the illuminated area changes in response to said relative movement; and
a processor configured to compute the amount of the relative movement from the electrical output based on the relationship between the electrical output and the illuminated area.

2. The imaging system of claim 1, wherein the optical component mounted on the second carrier section comprises one of the image forming medium and the lens element in a direction substantially perpendicular to the optical axis.

3. The imaging system of claim 1, further comprising a prism arranged to fold for folding the optical axis, wherein the optical component mounted on the second carrier section comprises the prism and the second carrier section has means to rotate the prism about a rotation axis substantially perpendicular to the image plane.

4. The imaging system of claim 1, further comprising a prism having a back face for folding the optical axis, wherein the optical component mounted on the second carrier section comprises the prism and the second carrier section has means to rotate the prism about a rotation axis substantially parallel to the image plane and the back face of the prism.

5. The imaging system of claim 1, further comprising:
a movement controller configured to determine an amount for moving said optical component based on the unwanted movement of the imaging system; and
a driving mechanism configured to move the second carrier section based on the determined amount.

6. The imaging system of claim 5, further comprising:
a movement sensor configured to detect the unwanted movement of the imaging system.

7. The imaging system of claim 6, wherein the movement sensor comprises one or more gyroscope sensors.

8. The imaging system of claim 1, wherein the image forming medium comprises an image sensor.

9. The imaging system of claim 1, wherein the position sensor further comprises:
a further reflection surface provided on said one of the first and second carrier sections, the further reflection surface located adjacent to a different edge of the carrier section surface,
a further light emitting element, disposed on said other of the first and second carrier sections spaced from the further reflection surface, for producing a different light beam to illuminate the further reflection surface such that one part of the different light beam encounters the further reflection surface to form a different illuminated area, and another part of the different light beam falls off the different edge of the carrier section surface, and
a further light sensor for sensing the light reflected from the different illuminated area for providing a farther electrical output having a relationship to the different illuminated area, so as to allow the processor to determine the relative movement also from the further electrical output.

10. The imaging system of claim 9, wherein the relative movement is determined based on a difference between the electrical output and the further electrical output.

11. A method for position sensing comprising:
providing a reflection surface in an image system, the image system comprising a plurality of imaging components arranged in relationship to an optical axis, the imaging components comprising at least an image forming medium and a lens element for projecting an image on the image forming medium. wherein at least one of the imaging components is mounted on a carrier for movement. and wherein the carrier has a first frame for fixedly mounting said one imaging component and a second frame movable relative to the first frame, wherein the reflection surface is mounted on one of the first and second frames, adjacent to an edge of a frame surface;
disposing a light emitting element on the other one of the first and second frames, wherein the light emitting element is positioned to produce a light beam for illuminating the reflection surface such that one part of the light beam encounters the reflection surface to form an illuminated area, and another part of the light beam falls off the edge of the frame surface;
sensing the light reflected from the illuminated area for providing an electrical output having a relationship to the illuminated area, wherein when the second frame is caused to undergo a movement relative to the first frame, the illuminated area changes in response to said relative movement; and
determining the amount of the relative movement from the electrical output based on the relationship between the electrical output and the illuminated area.

12. The method of claim 11, further comprising:
providing a further reflection surface adjacent to a further edge of the frame surface;
disposing a further light emitting element on said other one of the first and second frames, wherein the further light emitting element is positioned to produce a different light beam for illuminating the further reflection surface such that one part of the different light beam encounters the further reflection surface to form a further illuminated area, and another part of the different light beam falls off the further edge of the frame surface;
sensing the light reflected from the further illuminated area for providing a further electrical output having a relationship to the further illuminated area;
determining the difference between the electrical output and the further electrical output for providing a differential output; and
determining the amount of the relative movement from the differential output.

13. The method of claim 11, the second frame is movable relative to the first frame along a moving direction and the reflection surface has a width perpendicular to the moving direction, and that the illuminated area has a diameter smaller than the width of the reflection surface.

14. The method of claim 11, wherein the second frame is movable relative to the first frame along a moving direction and the reflection surface has a width perpendicular to the moving direction, and that the illuminated area has a diameter equal to the width of the reflection surface.

15. The method of claim 11, wherein the second frame is movable relative to the first frame along a moving direction and the reflection surface has a width perpendicular to the moving direction, and that the illuminated area has a diameter greater than the width of the reflection surface.

16. The method of claim 11, wherein the second frame is movable relative to the first frame along a moving direction and the reflection surface has a width varied along an axis parallel to the moving direction.

17. An image stabilizer module for use in an imaging system, said imaging stabilizer module comprising:
a carrier configured to shift a projected image relative to an image plane in response to an unwanted movement of the imaging system the imaging system comprising an image sensor located at the image plane and at least a lens element arranged to form the projected image on the image sensor, the lens element defining an optical axis, the carrier comprising a first carrier section fixedly connected to a body portion of the imaging system and a second carrier section for mounting said one of the image sensor and the lens element for movement relative to the first carrier section;
a position sensor arranged to sense the position of the second carrier section relative to the first carrier section, said position comprising:
a reflection surface provided on one of the first and second carrier sections, the reflection surface located adjacent to an edge of a carrier section surface,
a light emitting element, disposed on the other of the first and second carrier sections spaced from the reflection surface, for producing a light beam to illuminate the reflection surface such that one part of the light beam encounters the reflection surface to form an illuminated area, and another part of the light beam falls off the edge of the carrier section surface, and
a light sensor configured to sense the light reflected from the illuminated area for providing an electrical output having a relationship to the illuminated area, wherein when the second carrier section is caused to undergo a movement relative to the first carrier section, the illuminated area changes in response to said relative movement; and
a processor configured to compute the amount of the relative movement from the electrical output based on the relationship between the electrical output and the illuminated area.

18. The image stabilizer module of claim 17, wherein the optical component mounted on the second carrier section comprises one of the image forming medium and the lens element in a direction substantially perpendicular to the optical axis.

19. The image stabilizer module of claim 17, further comprising a prism for folding the optical axis, wherein the optical component mounted on the second carrier section comprises the prism and the second carrier section has means to rotate the prism about a rotation axis substantially perpendicular to the image plane.

20. The image stabilizer module of claim 17, further comprising a prism having a back face for folding the optical axis, wherein the optical component mounted on the second carrier section comprises the prism and the second carrier section has means to rotate the prism about a rotation axis substantially parallel to the image plane and the back face of the prism.

21. The image stabilizer module of claim 17, further comprising:
a movement controller configured to determine an amount for moving said one of the image forming medium and the lens element based on the unwanted movement of the imaging system; and
a driving mechanism for moving the second carrier section based on the determined amount.

22. The image stabilizer of claim 21, further comprising:
a movement sensor arranged to sense the unwanted movement of the imaging system.

23. A position sensing module for use in an imaging system, said position sensing module comprising:
a reflection surface located in a carrier in the image system having a plurality of imaging components, the imaging components comprising an image sensor located on an image plane and a lens element arranged to project an image on the image sensor, the image sensor defining an optical axis wherein one of the imaging components is mounted on the carrier for movement in a direction substantially perpendicular to the optical axis for shifting the projected image relative to the image plane, and wherein the reflection surface is provided on a first part of the carrier, the reflection surface provided near an edge of a part surface;
a light emitting element, disposed on a second part of the carrier spaced from the reflection surface, for producing a light beam to illuminate the reflection surface such that one part of the light beam encounters the reflection surface to form an illuminated area, and another part of the light beam falls off the edge of the part surface, wherein at least one of the first and second parts is movable relative to each other and wherein when a relative movement occurs, the illuminated area changes in response to the relative movement; and
a light sensor arranged to sense the light reflected from the illuminated area for providing an electrical output having a relationship to the illuminated area so as to determine the relative movement amount from the electrical output based on the relationship between the electrical output and the illuminated area.

24. The position sensing module of claim 23, further comprising:
a further reflection surface adjacent to a further edge of the part surface;
a further light emitting element disposed on the second part of the carrier to produce a different light beam for illuminating the further reflection surface such that one part of the different light beam encounters the further reflection surface to form a further illuminated area, and another part of the different light beam falls off the further edge of the part surface; and
a further light sensor for sensing the light reflected from the further illuminated area for providing a further electrical output having a relationship to the further illuminated area so that the relative movement amount is also determined from the further electrical output based on the relationship between the further electrical output and the further illuminated area.

25. The position sensing module of claim 24, wherein the relative amount is determined based on a difference between the electrical output and the further electrical output.

26. The position sensing module of claim 23, wherein the second part is movable relative to the first part along a moving direction and the reflection surface has a width perpendicular to the moving direction, and that the illuminated area has a diameter smaller than the width of the reflection surface.

27. The position sensing module of claim 23, wherein the second part is movable relative to the first part along a moving direction and the reflection surface has a width perpendicular to the moving direction, and that the illuminated area has a diameter equal to the width of the reflection surface.

28. The position sensing module of claim 23, wherein the second part is movable relative to the first part along a moving direction and the reflection surface has a width perpendicular to the moving direction, and that the illuminated area has a diameter greater than the width of the reflection surface.

29. The position sensing module of claim 23, wherein the second part is movable relative to the first part along a moving direction and the reflection surface has a width varied along an axis parallel to the moving direction.

30. The position sensing module of claim 23, further comprising:
processor, operatively connected to the light sensor, for determining the relative movement amount, in response to the electrical output.

31. An apparatus for use in an imaging system, said position sensing module comprising:
means for reflection provided in a carrier in the image system having a plurality of imaging components, the imaging components comprising an image sensor located on an image plane and a lens element arranged to project an image on the image sensor, the image sensor defining an optical axis, wherein one of the imaging components is mounted on the carrier for movement in a direction substantially perpendicular to the optical axis for shifting the projected image relative to the image plane, and wherein said means for reflection is provided on a first part of the carrier, near an edge of a part surface;
means for illumination, disposed on a second part of the carrier spaced from the reflection surface, for producing a light beam to illuminate the reflection surface such that one part of the light beam encounters said means for reflection to form an illuminated area, and the other part of the light beam falls off the edge of the part surface, wherein at least one of the first and second parts is movable relative to each other and wherein when a relative movement occurs, the illuminated area changes in response to the relative movement; and
